(19) United States
(12) Patent Application Publication
(10) Pub. No.: US 2025/0165200 A1
(43) Pub. Date: May 22, 2025

(54) PRINT SYSTEM TERMINAL, PRINT SYSTEM, AND PRINT SYSTEM INFORMATION PROCESSING METHOD

(71) Applicant: Toshiba Tec Kabushiki Kaisha, Tokyo (JP)

(72) Inventor: Tomoki MAEDA, Sunto Shizuoka (JP)

(21) Appl. No.: 18/754,809

(22) Filed: Jun. 26, 2024

(30) Foreign Application Priority Data
Nov. 17, 2023 (JP) 2023-196156

(51) Int. Cl. G06F 3/12

(52) U.S. Cl. CPC G06F 3/1285; G06F 3/1253

(57) ABSTRACT

An embodiment provides enhanced security for printing of print jobs in networked printing systems and the like. In one example, a print system terminal includes a processing circuit and a communication interface to connect to a print system server. The processing circuit is configured to receive, from an input unit, a selection of a selected file to be printed by a printer of a print system and acquire print release setting information for the selected file. The processing circuit then outputs the print release setting information and other information corresponding to the selected file to the print system server.

### CROSS-REFERENCE TO RELATED APPLICATION

This application is based upon and claims the benefit of priority from Japanese Patent Application No. 2023-196156, filed Nov. 17, 2023, the entire contents of which are incorporated herein by reference.

### FIELD

Embodiments described herein relate generally to a print system terminal, print system, and a print system information processing method for improved security in handling of mobile print jobs and the like.

### BACKGROUND

In recent years, systems in which a printer prints a document or the like from a smartphone, a tablet terminal, or the like has been widely adopted. In the related art, a user who logs in to a mobile application (“app”) or the like can transmit a print job by sending an account unique code, such as a PIN code, associated with the logged-in user to the printer before printing.

In such a system, the user who transmits the print job and the user who performs the printing are assumed to be the same person.

However, in the related art, when the printing is being requested to be performed by another person, such as in a case of a remote work, a business trip, or the like, it may be necessary to tell another person the account unique code. Therefore, a security risk, such as leakage of the account unique code, is more likely to occur.

### BRIEF DESCRIPTION OF THE DRAWINGS

FIG. 1 is a block diagram schematically illustrating a print system according to an embodiment.

FIG. 2 is a block diagram schematically illustrating an image forming device.

FIG. 3 is a block diagram schematically illustrating a server.

FIG. 4 is a block diagram schematically illustrating a user terminal.

FIG. 5 is a diagram illustrating an example of a setting image displayed on a user terminal.

FIG. 6 is a diagram illustrating another example of a setting image.

FIG. 7 is a sequence diagram of information processing by a print system.

FIG. 8 is a flowchart of information processing related to account registration by a server.

FIG. 9 is a flowchart of information processing related to parameter setting by a user terminal.

FIG. 10 is a flowchart of information processing related to registration of job information by a server.

FIG. 11 is a flowchart of information processing related to print processing by an image forming device.

FIG. 12 is a flowchart of information processing related to print processing by a server.

FIG. 13 is a flowchart of information processing related to print processing by an image forming device.

FIG. 14 is a flowchart of information processing related to print processing by a server.

### DETAILED DESCRIPTION

A technique, technology, or method provided as a solution for avoiding the risk of leakage of an account unique code and enhancing security as compared to the related art is required.

Embodiments described herein relate to techniques for enhancing security of printing in networked and/or multi-user environments or the like.

According to one embodiment, a print system terminal includes a processing circuit and a communication interface to connect to a print system server. The processing circuit is configured to receive, from an input unit, a selection of a selected file to be printed by a printer of a print system and acquire print release setting information for the selected file. The processing circuit then outputs the print release setting information and other information corresponding to the selected file to the print system server. In this context, the print release setting information can, without limitation, include user selections of options for print releasing in the print system such as requiring a unique job code set for the file to be entered at a printer for print release, requiring a user account code to be entered at the printer for print release, or both type codes to be entered. In some instances, multiple files to be printed can share the same unique job code when the user selects this as an option.

Hereinafter, certain example embodiments will be described with reference to the drawings. In the drawings, the same components are denoted by the same reference symbols, and redundant description thereof may be omitted.

### Configuration Example

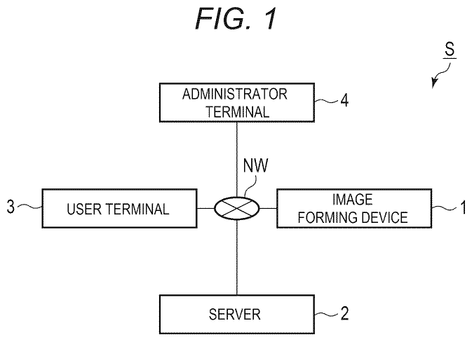

FIG. 1 is a block diagram illustrating an example of an information processing system S (print system) according to an embodiment.

The information processing system S includes an image forming device 1, a server 2, a user terminal 3, and an administrator terminal 4. The image forming device 1, the server 2, the user terminal 3, and the administrator terminal 4 are communicably connected to each other via a network NW. The network NW comprises one or more networks such as the Internet, a mobile network, and a local area network (LAN). The network may be or include a wireless network or a wired network. The information processing system S provides a print service for printing documents or the like selected for printing by a user of the user terminal 3. The selected documents are then printed using the image forming device 1. In the present context, the information processing system S may be a system including at least two elements from among the depicted image forming device 1, server 2, user terminal 3, and administrator terminal 4.

The image forming device 1 is an electronic device having an electrophotographic printing function. The image forming device 1 can be a multifunction peripheral (MFP) having a copy function, a printing function, a facsimile function, a scanner function, and the like.

The server 2 is a device that collects data and processes the collected data. The server is a computer or the like. The server 2 is communicably connected to the image forming device 1, the user terminal 3, and the administrator terminal 4 via the network NW. The server 2 receives various kinds of data from the image forming device 1, the user terminal 3, and the administrator terminal 4, and outputs various kinds of data to the image forming device 1, the user terminal 3, and the administrator terminal 4. The server 2 is an example of an information processing device and a print system server.

The user terminal 3 is some device capable of communicating with another device. The user terminal 3 can be a personal computer (PC), a smartphone, a tablet terminal, or the like. The user terminal 3 is communicably connected to the server 2 via the network NW. The user terminal 3 is an example of an information processing terminal or a print system terminal. The user terminal 3 is used by a user of a print service or the like. For example, the user operates the user terminal 3 to activate a dedicated application program for a particular print service. It is assumed that the application program for the print service is stored in the user terminal 3. The user inputs setting information (e.g., print parameters and/or user preference selections) related to printing and the like via the application program. The information processing system S may include or interact with a plurality of user terminals 3. In the following description, the user may be referred to as, or considered to be, an operator, owner, or the like of a user terminal or a person registered or otherwise permitted to use the print service.

The administrator terminal 4 is a device capable of communicating with another device. The administrator terminal 4 can be a PC, a smartphone, a tablet terminal, or the like. The administrator terminal 4 is communicably connected to the server 2 via the network NW. The administrator terminal 4 is used by an administrator, manager or the like who manages, tracks, or monitors information regarding the users who use the print service. A user of the administrator terminal 4 may, for example, register the users who uses the print service in the server 2.

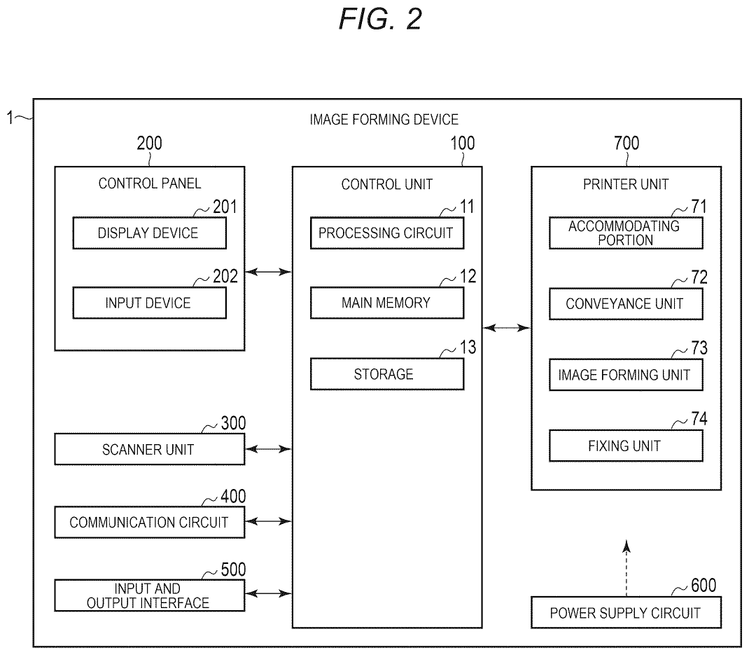

FIG. 2 is a block diagram schematically illustrating the image forming device 1 according to the embodiment.

The image forming device 1 is any electronic device having an electrophotographic printing function. The image forming device 1 can be a multi-functional peripheral (MFP) apparatus having a copy function, a printing function, a facsimile function, a scanner function, and the like.

The image forming device 1 includes a control unit 100, a control panel 200, a scanner unit 300, a communication circuit 400, an input and output (I/O) interface 500 (“interface 500”), a power supply circuit 600, and a printer unit 700.

The control unit 100 controls operations of each sub-unit of the image forming device 1. The control unit 100 includes a processing circuit 11, a main memory 12, and a storage 13.

The processing circuit 11 corresponds to a central part of the image forming device 1. The processing circuit 11 can be one or more circuits that execute processing for a plurality of functions. For example, the circuit is a processor, an application specific integrated circuit (ASIC), or a field-programmable gate array (FPGA), but is not limited thereto. For example, the processor is a central processing unit (CPU) or a graphics processing unit (GPU), but is not limited thereto. The processing circuit 11 loads a program stored in advance in the main memory 12 or the storage 13 into the main memory 12. The program is a software program, algorithm, or the like capable of causing the processing circuit 11 to execute various types of processing. The processing circuit 11 executes the program to enable execution of the various types of processing.

The main memory 12 comprises a nonvolatile memory area and a volatile memory area. The main memory 12 stores an operating system or a program in the nonvolatile memory area. The main memory 12 uses the volatile memory area as a work area in which data can be appropriately rewritten by the processing circuit 11. For example, the main memory 12 includes a read only memory (ROM) as the nonvolatile memory area. For example, the main memory 12 includes a random access memory (RAM) as the volatile memory area.

The storage 13 corresponds to an auxiliary storage part of the image forming device 1. For example, the storage 13 can be a hard disk drive (HDD). The storage 13 may be a semiconductor storage medium such as a solid-state drive (SSD) in addition to or instead of the HDD. The storage 13 stores programs, data used by the processing circuit 11 to execute various types of processing, and data generated by the processing of the processing circuit 11. The storage 13 may store print data. The storage 13 is an example of a storage device.

The control panel 200 comprises a display device 201 and an input device 202.

The display device 201 is capable of displaying various images under control of the processing circuit 11. The display device 201 is a liquid crystal display, an organic electro luminescence (EL), or the like, but is not limited thereto. The input device 202 is capable of receiving operator inputs or the like and providing corresponding data or instructions to the image forming device 1. The input device 202 may include an input button, a keypad, a touch panel, or the like.

The scanner unit 300 reads images such as characters, graphics, and photographs drawn on a sheet placed at a predetermined position. The scanner unit 300 includes a line sensor. The line sensor may be of a charge coupled device (CCD) type. The line sensor may be of a contact image sensor (CIS) type. The scanner unit 300 generates image data based on an image read using the line sensor. The scanner unit 300 transmits the generated image data to the control unit 100. The control unit 100 stores the received image data in the storage 13 or transmits the image data to the printer unit 700. The scanner unit 300 is an example of a scanner part.

The communication circuit 400 is an interface for communicably connecting the image forming device 1 and the server 2 via a wired or wireless network.

The interface 500 is for connecting the image forming device 1 to an external device. The interface 500 can include a connector for a wired cable to be attached to the image forming device 1.

The power supply circuit 600 converts AC power supplied from a commercial power supply into DC power, and supplies power to each unit of the image forming device 1. The power supply circuit 600 may be controlled by the processing circuit 11.

The printer unit 700 forms an image on a sheet. The image to be formed can include text, characters, pictures, or the like. The printer unit 700 forms an image on the sheet based on image data transmitted from a user terminal via the network as part of a printing function or based on the image data generated by the scanner unit 300 as part of a copy function. In the present example, the printer unit 700 is a tandem-type toner image transfer unit. The printer unit 700 includes an accommodating portion 71, a conveyance unit 72, an image forming unit 73, and a fixing unit 74.

The accommodating portion 71 accommodates and/or stores sheets. The accommodating portion 71 includes a sheet feeding cassette and a pickup roller. The sheet feeding cassette accommodates the sheets. The pickup roller picks up the sheets one by one from the sheet feeding cassette. The pickup roller supplies the picked-up sheet to the conveyance unit 72. The sheet includes an ID card including a wireless tag.

The conveyance unit 72 conveys the sheet in the printer unit 700. The conveyance unit 72 includes a plurality of rollers and a registration roller. The plurality of rollers include a roller that conveys a sheet supplied by the pickup roller to the registration roller. The plurality of rollers are provided on a downstream side of the fixing unit 74, and include a roller that discharges the sheet to a discharge tray. The registration roller conveys the sheet to a transfer unit in accordance with a timing at which the transfer unit of the image forming unit 73 transfers a toner image to the sheet.

The image forming unit 73 forms the toner image on the sheet. The image forming unit 73 includes an intermediate transfer belt, a plurality of developing units, an exposure unit, the transfer unit, or the like. The intermediate transfer belt is an endless belt. The plurality of developing units correspond to the number of types of toner. The plurality of developing units include a black developing unit, a cyan developing unit, a magenta developing unit, and a yellow developing unit. Each developing unit includes a photosensitive drum. Each developing unit includes a charger, a developing device, a primary transfer roller, a cleaning unit, and a static eliminator around the photosensitive drum. The photosensitive drum is a drum having a photosensitive layer on a surface thereof. The charger uniformly charges the photosensitive layer on the surface of the photosensitive drum. The developing device develops an electrostatic latent image on the surface of the photosensitive drum with toner. The developing device forms a toner image on the surface of the photosensitive drum. The primary transfer roller faces the photosensitive drum and sandwiches the intermediate transfer belt. The primary transfer roller transfers the toner image on the surface of the photosensitive drum onto the intermediate transfer belt. The cleaning unit removes untransferred toner on the surface of the photosensitive drum. The static eliminator irradiates the surface of the photosensitive drum with light. The static eliminator removes static electricity from the photosensitive layer of the photosensitive drum by light irradiation. The exposure unit irradiates the surface of the photosensitive drum of each developing unit with laser light via an optical system such as a polygon mirror. The exposure unit forms an electrostatic pattern as an electrostatic latent image on the surface of the photosensitive drum. The transfer unit transfers the charged toner image on a surface of the intermediate transfer belt to the sheet. The transfer unit includes a support roller and a secondary transfer roller configured to sandwich the intermediate transfer belt and the sheet from both sides in a thickness direction.

The fixing unit 74 applies heat and pressure to the sheet on which the toner image supplied from the image forming unit 73 is formed. The fixing unit 74 fixes the toner image formed on the sheet to the sheet by the heat and pressure.

Hardware configuration of the image forming device 1 is not limited to the above-described configuration. In the image forming device 1, the above-described components may be appropriately omitted and changed, and a new component may be added thereto.

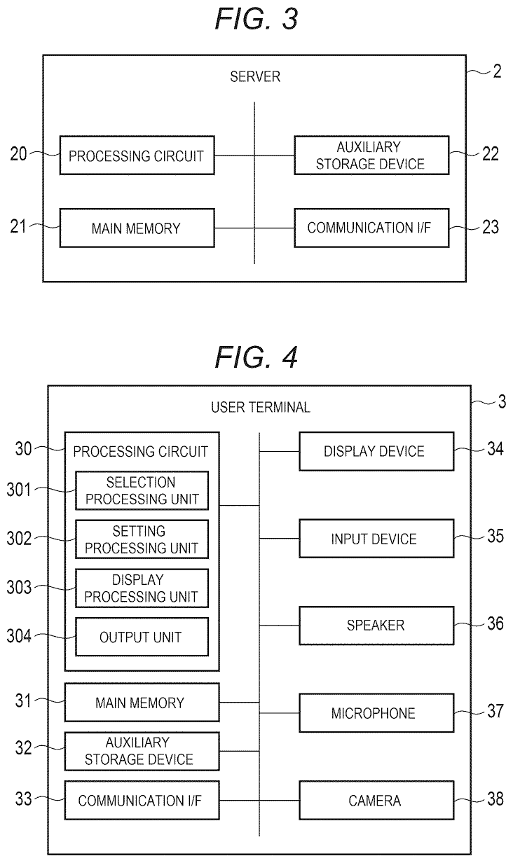

The server 2 is a device including a processing circuit 20, a main memory 21, an auxiliary storage device 22, and a communication interface 23. Respective units constituting the server 2 are connected to each other such that signals can be input and output therebetween. In FIG. 3, the interface is labeled as “I/F”.

The processing circuit 20 corresponds to a central part of the server 2. Similarly to the processing circuit 11, the processing circuit 20 can be one or more circuits that execute processing for a plurality of functions.

The main memory 21 may be implemented similarly to the main memory 12.

The auxiliary storage device 22 corresponds to an auxiliary storage part of the server 2. Similarly to the storage 13, the auxiliary storage device 22 includes one or more storage devices. The auxiliary storage device 22 is an example of a storage unit of the server 2.

The auxiliary storage device 22 stores account information. The account information concerns accounts given to each of the authorized users of the print service. In this context, a user can be a user of a user terminal 3 or a user of the administrator terminal 4. The account information includes a unique code for each account (e.g., an individual account code). The account information may include a unique code for each account group (e.g., a user group ID). An account group is a grouping of users of a plurality of accounts. The account group can be set by a user of an administrator terminal 4 or a user terminal 3. The account group is, for example, a group for classifying the users of the print service into different categories or the like. The classification of the users can concern a classification for permitting a print release of a print job. The print job is also more simply referred to as a job in the present description. A job also refers more broadly to any basic processing (copying, printing, and the like) operation of an image forming device 1. In the present embodiment, a print job is assumed and described in the examples. The classification of the users can be based on an organization scheme, departments, offices, positions (e.g., organization hierarchy level), work teams, sections, worksite locations, and the like. The classification of the users may be set according to an application for operation of the print service. The unique code for each account is also referred to as an account unique code, account unique information, and/or an account unique personal identification number (PIN).

The account unique code can be a code used for system authentication by PIN code authentication or the like when the print release is executed at an image forming device 1. The PIN code authentication refers to, for example, an authentication method in which a preset code is compared to an input code (code matching) before further processing is executed. The authentication method or process is not limited to PIN code authentication. The user can perform the print release of a job associated with an account by inputting an account unique code or other information to the image forming device 1. In this context, performing the print release of a job refers to causing (or permitting) the completion of a printing of a file or the like corresponding to the job. A job being associated with an account refers here to a job that was registered (input) by the user of the account. A job associated with an account may include any job for which print release is permitted to the account. Data stored in the auxiliary storage device 22 may be updated based on addition or deletion of the account information.

The auxiliary storage device 22 stores job data. The job data includes a job ID, a name of file to be printed, print data, setting information related to printing, setting information related to the job unique code, setting information related to a permitted account, and the like.

The job ID is identification information capable of uniquely identifying a job. The name of file to be printed can be any identification information capable of uniquely identifying the file to be printed. The name of file to be printed may be a name set for the file to be printed. The print data indicates print data corresponding to a file such as a document or an image to be printed. The job data is created for each file selected by the user to be printed. The setting information related to printing includes information such as a type of a print medium, a size of the print medium, and the number of copies to be printed. The setting information related to printing may include information such as a printing orientation (landscape/portrait) for the print medium, double-sided or single-sided printing, enlargement and reduction scaling (settings), and image density setting. The setting information related to printing can be any information related to image formation parameters, options, settings, or the like.

The setting information related to a job unique code includes information specifically related to settings of the job unique code itself. The job unique code is unique identification information issued for each job. The job unique code may also be referred to as a job unique PIN. The job unique code is a code that can be used for authentication such as a PIN code authentication. For example, when the job unique code is set for a job corresponding to a file to be printed, the user can perform a print release of the job by inputting the job unique code to the image forming device 1. The information related to the setting of a job unique code includes information indicating whether the job unique code is active, set, or previously set. After the job unique code has been set for a job, the information related to the job includes the job unique code.

The setting information related to a permitted account is information indicating an account for which a print release of a job is permitted. The permitted account may indicate a time range for the print release. An example where accounts for which a print release is permitted for a job J1 are an account A and an account B will be described. Information related to a permitted account for the job with a job ID of “J1” is information corresponding to the account A and the account B. The information related to the permitted account may indicate an account group (e.g., a list of accounts) for which the print release of the job is permitted. The information related to the permitted account may be an account unique code of a single account for which the print release of the job is permitted. When print release of the job is permitted only for the user who registers the job, the information related to the permitted account may include the account unique code of just the user who registers the job.

The job data may include the account unique code of the user who registers the job. For example, a case where a user U1 selects a file F1 and a file F2 as targets to be printed (print targets) will be described. Job data corresponding to the file F1 and job data corresponding to the file F2 both include the account unique code of the user U1. The data stored in the auxiliary storage device 22 may be updated based on additions or deletions of the job data. The job data is an example of information related to a file to be printed.

The auxiliary storage device 22 may store data of a file (such as a document file or an image file) to be printed. The auxiliary storage device 22 may store the data of the file to be printed together with identifiable information. The data stored in the auxiliary storage device 22 may be updated based on addition or deletion of the data of the file to be printed.

The communication interface 23 includes various interfaces that connect the server 2 to other devices in a communicable manner via the network NW in accordance with a predetermined communication protocol.

Hardware configuration of the server 2 is not limited to the above-described configuration. In the server 2, above-described components may be appropriately omitted and changed, and additional components may be added thereto.

FIG. 4 is a block diagram illustrating the user terminal 3.

The user terminal 3 includes a processing circuit 30, a main memory 31, an auxiliary storage device 32, a communication interface 33, a display device 34, an input device 35, a speaker 36, a microphone 37, and a camera 38. Respective units constituting the user terminal 3 are connected to each other such that signals can be input and output therebetween. In FIG. 4, the interface is described as “I/F”.

The processing circuit 30 corresponds to a central part of the user terminal 3. Similarly to the processing circuit 11, the processing circuit 30 comprises one or more circuits that execute processing for a plurality of functions.

The main memory 31 may be implemented similarly to the main memory 12. The main memory 31 is an example of a storage unit of the user terminal 3.

The auxiliary storage device 32 corresponds to an auxiliary storage part of the user terminal 3. Similarly to the storage 13, the auxiliary storage device 32 includes one or more storage devices.

The auxiliary storage device 32 may store data of a file such as a document or an image to be printed. The auxiliary storage device 32 is an example of the storage unit of the user terminal 3. The data stored in the auxiliary storage device 32 may be updated based on addition or deletion of the data of the file to be printed.

The communication interface 33 includes various interfaces that connect the user terminal 3 to other devices in a communicable manner via a network in accordance with a predetermined communication protocol.

The display device 34 is capable of displaying various images under control of the processing circuit 30. For example, the display device 34 is a liquid crystal display, an electro luminescence (EL) display, or the like. The display device 34 includes a touch panel. The display device 34 is an example of a display screen or display unit. The display device 34 can be referred to as a display unit of the user terminal 3.

The input device 35 is capable of receiving an instruction based on a user operation. The input device 35 may include a button-type input key, keypad, keyboard, or the like. The input device 35 may include a touch panel capable of realizing the functions of an input key, keypad, keyboard, or the like.

The speaker 36 is a device capable of outputting sounds under control of the user terminal 3. The sounds may be speech, beeps, tones, or the like.

The microphone 37 is a device capable of receiving the sounds, such as speech or the like.

The camera 38 can be any device that acquires a photographed image or data based on a photograph.

The hardware configuration of the user terminal 3 is not limited to the above-described configuration. Various components may be appropriately omitted, altered, modified, or changed, and additional components may be added or substituted. For example, at least one of the display device 34, the input device 35, the speaker 36, the microphone 37, and the camera 38 may be an external device separate from the user terminal 3.

Functions implemented by the processing circuit 30 will be described.

The processing circuit 30 implements functions corresponding to a selection processing unit 301, a setting processing unit 302, a display processing unit 303, and an output unit 304. Units implemented by the processing circuit 30 can also be referred to a function or the like. The units described as implemented by the processing circuit 30 can also be considered to be implemented by a control unit or controller including the processing circuit 30 and the main memory 31.

The selection processing unit 301 receives a user selection of a file to be printed based on a user input operation. The selection processing unit 301 receives an instruction to select the file to be printed via the input device 35 from the user.

The setting processing unit 302 acquires setting information for the file to be printed. The setting processing unit 302 acquires setting information for a printing operation based on a user input operation. The setting processing unit 302 acquires setting information related to a print release based on a user operation. In this context, the setting information related to a print release includes at least one of information related to a job unique code setting and a permitted account setting. The settings related to the job unique code (job unique code setting) concern user selectable options available for the job unique code. The options related to the job unique code includes setting for using a common job unique code for selected files when there are a plurality of files to be printed, for using a different job unique code for each of the files to be printed, or not setting a job unique for the files to be printed.

“Setting a common job unique code” for selected files to be printed allows the setting of the same job unique code for all jobs (files) selected for printing by the same user. The example case where the user U1 selects both the file F1 and the file F2 as the print targets will be described. Here, the user U1 can decide (select) to set the same job unique code for both the file F1 and the file F2 jobs.

“Setting a different job unique code” for each of the files to be printed allows the setting of different job unique codes for respective jobs (files) to be printed by the same user. The example case where the user U1 selects the file F1 and the file F2 as the print targets will be described. In this case, the user U1 can decide (select) to set different job unique codes for each of the respective jobs for the file F1 and the file F2.

“Not setting a job unique code” allows for not setting any job unique code for the jobs (files) to be printed.

The settings related to the permitted account concern a selectable options related to the permitted account. The settings (options) related to the permitted account include permitting only the user who selected the file to be printed to perform the print release for the file, permitting only a preset user to perform the print release, or permitting any user (an unspecified user) to perform the print release. In this context, the user who selects the file to be printed corresponds to the user who registers the job. The preset user in this context corresponds to an account that is permitted to perform a print release of the job. An unspecified user in this context can be a user who is not registered for an account. The unspecified user can also be referred to as a guest user. The unspecified may include a user whose account is not registered or a user outside an organization.

Permitting only the user who selects the file to be printed to perform the print release means that only the user who selected the file to be printed can perform the printing. In this case, the permitted account is only the account of the user who selected the file to be printed. For example, the user who selected the file to be printed can print the file by inputting his or her own account unique code into the image forming device 1.

Permitting only a preset user to perform the print release means permitting a user other than the user who selected the file to be printed to perform the printing. The preset user is permitted to perform the print release. For example, when the user selects to permit only a preset user to perform the print release, the user selects the user(s) permitted to perform the print release. For example, a user U1 selects a file to print and sets (presets) a user A and a user E as the users permitted to perform the printing. In this case, the permitted accounts are accounts of the user A and the user E. The user A and the user E can thus print the file by inputting his or her own account unique code into the image forming device 1.

Permitting an unspecified user to perform the print release means any user, even one who is not registered for an account, can perform the print release. Permitting an unspecified user to perform the print release may include permitting all users to perform the print release. For example, the user can print the file without inputting an account unique code to the image forming device 1. In this case, the user who performs the printing simply identifies a job for the print release by using the job unique code.

The setting processing unit 302 may set the job unique code setting and/or the permitted account setting.

The display processing unit 303 processes aspects related to display on the display device 34.

The output unit 304 outputs setting information related to printing for each file, setting information related to the job unique code, and setting information related to the permitted account to the server 2 via the communication interface 33.

### Display Examples

Display examples for the display device 34 of the user terminal 3 will be described.

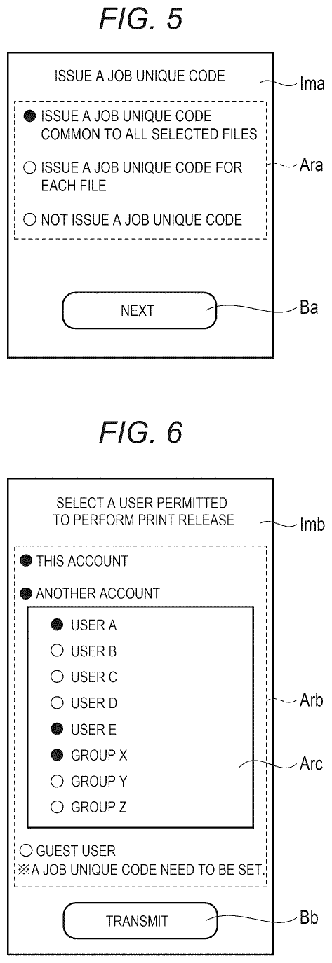

FIG. 5 is a diagram illustrating an example of a setting image displayed on the user terminal 3 according to an embodiment. FIG. 5 illustrates a setting image Ima displayed on the display device 34 after the file to be printed is selected by the user on the user terminal 3. Here, the setting image Ima concerns settings related to the job unique code. The setting image Ima includes a setting area Ara and a “next” button Ba.

The setting image Ima includes text indicating that the screen concerns setting related to the job unique code. The text is such as “issue a job unique code”.

The setting area Ara is an area in which a setting related to the job unique code can be selected. The setting area Ara includes a plurality of options related to the job unique code. The setting area Ara includes, for example, options such as “issue a job unique code common to all selected files”, “issue a job unique code for each file”, and “not issue a job unique code”. The user selects a desired setting from the options. The setting area Ara may include one or more buttons for inputting a selection of a setting by the input device 35.

The “next” button Ba is for transitioning to the next image (screen) by selection of the input device 35. When a selection of the setting related to the job unique code is completed, the user selects the “next” button Ba by touch input or the like. Based on the selection of the “next” button Ba by the user, the setting image Ima is transitioned to screen for executing a setting related to a permitted account as illustrated in FIG. 6.

FIG. 6 is a diagram illustrating an example of a setting image displayed on the user terminal 3 according to an embodiment. FIG. 6 illustrates, for example, a setting image Imb displayed on the display device 34 after a setting related to the job unique code has been performed by the user on the user terminal 3. The setting image Imb is for entering of settings related to the permitted account. The setting image Imb includes a setting area Arb and a “transmit” button Bb.

The setting image Imb includes text indicating that the screen concerns settings related to the permitted account. The text may be such as “select a user permitted to perform print release”.

The setting area Arb is an area in which a setting related to the permitted account can be selected. The setting area Arb includes a plurality of options related to the permitted account. The setting area Arb includes, for example, options such as “this account”, “another account”, and “guest user”. The “this account” option indicates the account of the user who selects the file to be printed is the permitted account. The setting of “this account” permits only the user who selects the file to be printed to perform the print release. The setting of “another account” indicates that some account other besides, or in addition to, the user who selects the file to be printed is a permitted account. The setting of “another account” permits the user who inputs the print job to select one or more other users who are authorized (permitted) to perform the print release of the submitted print job. The setting of “another account” provides for a permitted account selection area Arc for selecting a permitted account. The permitted account selection area Arc displays information capable of identifying another registered account or a registered group in a selectable manner. The information capable of identifying the registered account or the registered group is, for example, an account name or a group name. By selecting the setting of “another account” and then selecting the permitted account(s), the user can select the other users who can print release the file to be printed. The setting of “guest user” indicates a user other than the user who selects the file to be printed and users of the registered account or the registered group. The setting of “guest user” permits an unspecified user (e.g., any user) to perform the print release. By selecting the setting of “guest user”, the user who submits a print job can permit any user including those other than users with an registered account or in a registered group to print the file. The user selects a desired setting from the options related to the permitted account setting. The setting area Arb may include one or more buttons for selecting a setting by the input device 35.

The “transmit” button Bb is for outputting setting information related to the print release. When the selection of the setting related to the permitted account has been completed, the user selects the “transmit” button Bb by touch input or the like. Based on the selection of the “transmit” button Bb by the user, the user terminal 3 outputs the setting information related to the print release to the server 2. The user terminal 3 may output setting information for each file to be printed, setting information related to the job unique code, and setting information related to the permitted account to the server 2 with selection of the “transmit” button Bb.

### Operation Example

Certain processing by the information processing system S will be described.

In the following description operations, processes, or functions described as performed or executed by an image forming device 1 may be considered as performed or executed by a processing circuit 11 of the image forming device 1. Similarly, operations, processes, or functions described as performed or executed by a server 2 may be considered as performed or executed by the processing circuit 20 of the server 2. Similarly, operations, processes, or functions described as performed or executed by a user terminal 3 may be considered as performed or executed by the processing circuit 30 of the user terminal 3. Similarly, operations, processes, or functions described as performed or executed by an administrator terminal 4 may be considered as performed or executed by a processing circuit of the administrator terminal 4.

The processing and procedures described below is merely one example provided for general description, and specific details of the described processing may be varied when possible. Likewise, in other examples, described processing can be omitted and/or replaced with other processing to achieve a similar result or the like. Additionally, in other examples, additional processing may be incorporated beyond the example description.

In the following, it is assumed that a user of a user terminal 3 registers a file to be printed and a user of the image forming device 1 prints the file to be printed.

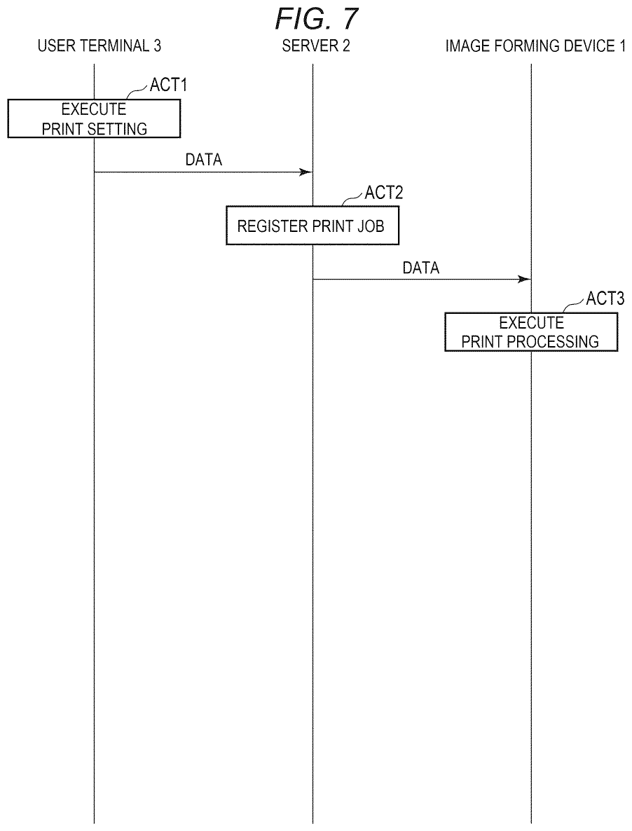

FIG. 7 is a flowchart illustrating a processing procedure in an image processing system S according to an embodiment.

It is assumed here that the user of the user terminal 3 is a registered user. That is, the user of the user terminal 3 has an account with the print service (image processing system S). For example, the user of the user terminal 3 starts a dedicated application program to begin use of the print service. The user logs into the dedicated application program via the user terminal 3.

The user terminal 3 executes a print setting based on the user operation (ACT 1) at the user terminal 3. In ACT 1, the user terminal 3, for example, receives a selection of a file to be printed. The user then provides setting information related to printing, setting information related to a job unique code, setting information related to a permitted account, and the like for the selected file to be printed via the user terminal 3. The user terminal 3 then outputs print data for the selected file to be printed to the server 2. In some examples, the user terminal 3 may output information capable of identifying the file to be printed to the server 2 rather than the file itself. The user terminal 3 may separately output, to the server 2, setting information related to printing of the file to be printed and setting information related to print release.

The server 2 acquires the print data of the file to be printed and the setting information for the file to be printed.

The server 2 registers a print job (ACT 2). In ACT 2, for example, the server 2 creates, stores, or updates job data for each file to be printed. The server 2 stores print data and setting information for each job. The server 2 issues a job unique code based on the provided setting information related to the job unique code. The server 2 associates the job unique code with the job ID and stores the job unique code as part of the job data. In this context, registering the print job can include creating, storing, or updating the job data for each print job.

The image forming device 1 executes print processing based on a user operation (ACT 3). In ACT 3, for example, the image forming device 1 acquires an account unique code based on a user operation at the image forming device 1. The image forming device 1 outputs the input account unique code to the server 2. The server 2 executes authentication based on the account unique code. In general, the authentication of an account may be executed by any known technique. The server 2 outputs job data associated with the account unique code to the image forming device 1. In some examples, server 2 may output information capable of identifying a job associated with the account unique code to the image forming device 1 rather than the job data itself. In some cases, the image forming device 1 may request the job data from the server 2 for a job selected by the user based on a user operation at the image forming device 1 or the like. In such a case, the server 2 may output the job data of the selected job to the image forming device 1 based on the request from the image forming device 1. The image forming device 1 may execute authentication processing for the job based on setting information related to print release of the job. The image forming device 1 ultimately executes print processing (ACT 3) based on the acquired job data.

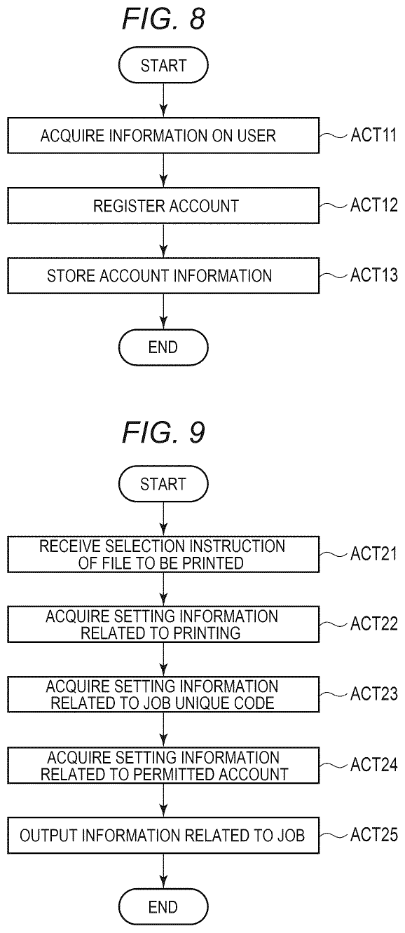

FIG. 8 is a flowchart illustrating an example of a processing related to account registration executed by the server 2 according to an embodiment.

In the following processing, it is assumed that it is the user of administrator terminal 4 who inputs the information for registering an account. It is assumed that the user of the administrator terminal 4 logs into an application of the print service or a portal site of the print service. The user of the administrator terminal 4 can be a user who has been given management authority for managing information about the users who use the print service.

The user of the administrator terminal 4 (e.g., an administrator) inputs information via an input device or the like. The information input about a user of the print service may include user identifying information, a creation instruction for an account (e.g., an individual user account), a creation instruction of an account group, and the like. The user identifying information includes information such as a user name. creation instruction of an account group includes an instruction to select a plurality of accounts to be included in the account group. The administrator terminal 4 outputs the account information and the like to the server 2.

The processing circuit 20 of the server 2 acquires the information about the user (user account information and the like) from the administrator terminal 4 (ACT 11). In ACT 11, the processing circuit 20 acquires, for example, user information along with a creation instruction for an individual user account. In other examples, the processing circuit 20 may acquire a creation instruction for an account group along with individual user account information or the like.

The processing circuit 20 registers an account based on the acquired user information and creation instruction (ACT 12). In ACT 12, for example, the processing circuit 20 issues an account unique code for the just-registered user account.

The processing circuit 20 stores the appropriate account information (ACT 13). In ACT 13, for example, the processing circuit 20 stores the account information by the account unique code for each account. The account information may include an account name. The account name is identification information capable of uniquely identifying an account. In some cases, the account name may be the same as the user name included in the user information at registration. The account information may include information about an account group. The processing circuit 20 generates for an account group based on the creation instruction of the account group. The information about the account group includes an account group name and information about the other accounts to be included in the account group. The account group name is identification information capable of uniquely identifying an account group. The information about the accounts to be included in the account group may include an account name for each of the individual accounts or the like.

In ACT 12, the processing circuit 20 may issue an account group unique code for each account group created based on a creation instruction for the account group(s).

In some cases, an account may be created by the user of the user terminal 3. In this case, the user terminal 3 may output the user information and the creation instruction of the account to the server 2 based on a user operation. The server 2 may create an account based on the user information and the creation instruction thus received form the user terminal 3.

FIG. 9 is a flowchart of information processing related to setting operations by the user terminal 3 according to an embodiment.

The user of the user terminal 3 logs into an application of the print service using a registered account. The server 2 can execute an account authentication and issue a print token. The server 2 provides the print token to the user terminal 3.

The following processing is started after execution of log-in authentication of the user by the server 2.

The processing circuit 30 of the user terminal 3 receives the selection of a file to be printed (ACT 21). The processing in ACT 21 may be executed by the selection processing unit 301. In ACT 21, the processing circuit 30 acquires the selection of the file to be printed based on a user operation. The user operation is, for example, an operation of selecting the file to be printed via the input device 35. The processing circuit 30 may receive the selection of a plurality of files to be printed.

The processing circuit 30 next acquires the setting information related to printing of the file (ACT 22). The processing in ACT 22 may be executed by the setting processing unit 302. In ACT 22, the processing circuit 30 can acquire a setting instruction related to printing of the file based on a user operation. The user operation is, for example, an operation of selecting setting information via the input device 35. The processing circuit 30 may cause the display device 34 to display a screen image by which the setting information related to printing can be selected by the user. The processing of displaying the screen image from which the setting information related to printing can be selected may be executed by the display processing unit 303. When a selection of a plurality of files to be printed is received, the processing circuit 30 may acquire setting information related to printing for each individual file. The processing circuit 30 may apply the setting information to all of the files to be printed based on the setting instruction.

The processing circuit 30 also acquires the setting information related to the job unique code for the file(s) to be printed (ACT 23). The processing in ACT 23 may be executed by the setting processing unit 302. In ACT 23, the processing circuit 30 acquires a setting instruction related to the job unique code for the file to be printed based on a user operation. The user operation is, for example, an operation of selecting a setting related to the job unique code via the input device 35. The settings related to the job unique code can be a setting for a common job unique code for selected files to be printed or a different job unique code for each of the files to be printed. Alternatively, the setting can be for there to be no job unique code for the files to be printed. Here, the user operation is an operation of selecting any of the available settings related to the job unique code. The processing circuit 30 may cause the display device 34 to display a screen image from which a setting related to the job unique code can be selected. The processing for displaying the screen image may be executed by the display processing unit 303. When a selection including a plurality of files to be printed is received, the processing circuit 30 may acquire setting information related to the job unique code for each file to be printed. The processing circuit 30 may apply the setting information related to the job unique code to all of the plurality of files to be printed based on the setting instruction.

The processing circuit 30 can also acquire setting information related to the permitted account for the file to be printed (ACT 24). The processing in ACT 24 may be executed by the setting processing unit 302. In ACT 24, the processing circuit 30 acquires a setting instruction related to the permitted account(s) for the file to be printed based on a user operation. The user operation is, for example, an operation of selecting a setting related to the permitted account via the input device 35. The settings related to the permitted account includes a setting for permitting only the user who selected the file to be printed to perform the print release, permitting only a preset user to perform the print release, or permitting any (unspecified) user to perform the print release. The user operation is an operation of selecting at least one of options of the setting related to the permitted account. The processing circuit 30 may cause the display device 34 to display a screen image from which the setting related to the permitted account can be selected. The process of displaying the screen image can be selected may be executed by the display processing unit 303. When the option for no job unique code is selected in ACT 23, the processing circuit 30 may execute control such that an unspecified user option is not permitted to perform the print release and the option for such cannot be selected. For example, the processing circuit 30 may display the screen image from which the setting related to the permitted account can be selected in a mode in which the option for permitting an unspecified user to perform the print release cannot be selected. When a selection of a plurality of files to be printed is received, the processing circuit 30 may acquire setting information related to the permitted account for each file to be printed or may apply the setting information related to the permitted account to all of the plurality of files to be printed based on the setting instruction. The ordering of the processing of ACT 23 and ACT 24 may be changed. For example, the processing circuit 30 may acquire the setting information related to the permitted account after acquiring the setting information related to the job unique code, or may acquire the setting information related to the job unique code after acquiring the setting information related to the permitted account.

The processing circuit 30 outputs information related to a job to the server 2 (ACT 25). The information related to the job is an example of the information related to the file to be printed. The processing in ACT 25 may be executed by the output unit 304. In ACT 24, for example, the processing circuit 30 outputs the print data of the selected file to be printed to the server 2. The processing circuit 30 outputs the setting information related to printing of the file to be printed to the server 2. The processing circuit 30 outputs the setting information related to the job unique code of the file to be printed to the server 2. When the data of the file to be printed is stored in the server 2, the processing circuit 30 may output the information capable of identifying the file to be printed to the server 2. The processing circuit 30 outputs the setting information related to the permitted account to the server 2. The processing circuit 30 may generate the job unique code based on the setting information related to the job unique code and output the job unique code to the server 2.

According to this example, the user can change or set the setting related to the job unique code for each job. The user can set a job unique code for each job. The user can set a job unique code common to a plurality of jobs. The user can select not to set a job unique code. Therefore, the user can change a security level associated with the print release by selecting a setting for the job unique code according to a usage context of the file to be printed. For example, when the user sets a job unique code for each job, the image forming device 1 may require a different job unique code from the user who performs a print release for each job to be released. The information processing system S can enhance the security in printing by requesting the job unique code for each job individually. Also, a user who registers a job for printing does not need to give his or her own account unique code to the person who performs the print release. Therefore, the information processing system S can prevent a risk of a user's account unique code from leaking.

For example, when the user sets a common (shared) job unique code for a plurality of jobs, the image forming device 1 can request the common job unique code for the plurality of jobs from the user who performs the print release any of the plurality of jobs. The information processing system S requests the common job unique code, thereby enhancing the security in printing and further facilitating the print release of the plurality of jobs. Therefore, the information processing system S can enhance convenience for the user who registers the job and the user who performs the print release.

In addition, the user can change or set a setting related to the permitted account(s) for each job. The user can permit another user to perform the print release by setting the permitted account to correspond to the other user. The other user can use his or her own account unique code to perform the print release of the file to be printed. The information processing system S can request the account unique code of the permitted account for each job. The a user who registers the job does not need to inform the user who performs the print release of his or her own account unique code. Therefore, the information processing system S can prevent a risk of leakage of the account unique code. Further, the information processing system S may require both the account unique code of a permitted account and the job unique code before executing the print release for a particular job. Accordingly, the information processing system S can enhance the security in printing.

The user can permit any user (unspecified user) to perform the print release. The unspecified user can perform the print release by using just the job unique code. The information processing system S can request the job unique code from the unspecified user and execute the print release. Accordingly, the information processing system S can safely execute a print release even by a user who is not registered for an account. Therefore, with this setting, the information processing system S can omit the otherwise required processing of account registration or user authentication before print release. Accordingly, the information processing system S can enhance the convenience for the users.

### Modifications

In the flowchart illustrated in FIG. 9, the processing circuit 30 may acquire the setting information related to the job unique code and/or the setting information related to the permitted account for the file to be printed.

A case where the processing circuit 30 acquires only the setting information related to the job unique code will be described.

In ACT 21, the processing circuit 30 receives the selection of the file to be printed.

In ACT 22, the processing circuit 30 acquires the

setting information related to printing for the file.

In ACT 23, the processing circuit 30 acquires the setting information related to the job unique code for the file. The setting related to the job unique code can be the setting of a common job unique code for the selected file or a different job unique code for each of a plurality of files (jobs) to be printed. When a plurality of files are selected to be printed, the processing circuit 30 may acquire setting information related to the job unique code for each file separately or for all of the files to be printed. The processing circuit 30 may cause display on the display device 34 of a setting screen image before or after ACT 23 by which the settings related to the permitted account can be skipped by a user operation. The processing circuit 30 need not display a setting screen image for executing the settings related to the permitted account on the display device 34 regardless of the user operation.

In ACT 25, the processing circuit 30 outputs the information related to the job to the server 2.

According to this modified example, the user can execute the setting related to the job unique code for each job. The information processing system S will thus request a job unique code when the user performs the print release of the job at the image forming device 1. Therefore, the print release requires a user to have the job unique code. The user who performs the print release can print the job only by inputting the job unique code into the image forming device 1. For example, even if a guest user is to perform the print release, the information processing system S can enhance the security by still requesting the job unique code for the job before release. The user who registered the job does not need to inform any other user of his or her own account unique code to permit another to release the job for printing. Therefore, the information processing system S can avoid a risk of leakage of account unique codes.

A case where the processing circuit 30 acquires only the setting information related to the permitted account for the file to be printed will be described.

In ACT 21, the processing circuit 30 receives the selection of the file to be printed.

In ACT 22, the processing circuit 30 acquires the setting information related to printing for the file.

In ACT 24, the processing circuit 30 acquires the setting information related to the permitted account for the file. The settings related to the permitted account can permit only the user who selected the file to be printed to perform the print release or designate another particular user (or group of users) to perform the print release of the job. When a plurality of files to be printed is made, the processing circuit 30 may acquire setting information related to the permitted account for each file individually or collectively. Before or after ACT 24, the processing circuit 30 may cause the display device 34 to display a setting screen image by which the setting related to the job unique code can be skipped by the user operation. The processing circuit 30 need not display the setting screen image for executing the settings related to the job unique code on the display device 34 regardless of the user operation.

In ACT 25, the processing circuit 30 outputs the information related to the job to the server 2.

According to this example, the user can execute the setting related to the permitted account for each job. The information processing system S will then request an account unique code when the print release of the job is performed at the image forming device 1. The user who performs the print release will need to have a permitted account unique code. Therefore, the user who performs the print release can print any job for which print release is permitted to the account unique code. For example, even when a job unique code is not set for a job, the information processing system S can permit only a designated (permitted) user to print the job. Therefore, the information processing system S can enhance the security in printing by requesting an account unique code before release. The user who registers the job does not need provide anyone else with his or her own account unique code. Therefore, the information processing system S can avoid a risk of leakage of account unique codes.

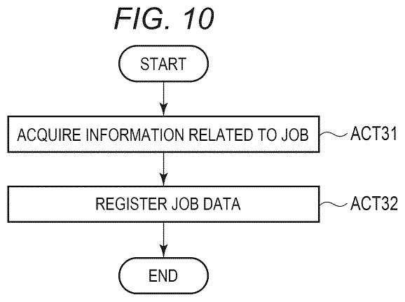

FIG. 10 is a flowchart illustrating an example of a processing procedure of information processing related to registration of job information by the server 2 according to an embodiment.

The processing circuit 20 of the server 2 acquires information related to the job from the user terminal 3 (ACT 31). In ACT 31, the processing circuit 20 acquires the print data of the file to be printed from the user terminal 3. The processing circuit 20 also acquires the setting information related to printing of the file from the user terminal 3. The processing circuit 20 acquires the setting information related to the job unique code of the file to be printed from the user terminal 3. The processing circuit 20 acquires the setting information related to the permitted account of the file to be printed from the user terminal 3. When the data of the file to be printed is stored in the server 2, the processing circuit 20 may acquire the information capable of identifying the file to be printed from the user terminal 3.

The processing circuit 20 registers job data based on the information related to the job (ACT 32). In ACT 32, the processing circuit 20 creates the job data for each file to be printed. The processing circuit 20 stores a job ID, print data, setting information related to printing, setting information related to a job unique code, and setting information related to a permitted account as the job data for each file to be printed. The processing circuit 20 issues a job unique code if appropriate according to the setting information. The processing circuit 20 associates the job unique code with the job ID and stores the job unique code. The processing circuit 20 may update the job data each time the information related to the job is acquired. The processing circuit 20 stores the job data in the auxiliary storage device 22. When a job unique code is acquired from the user terminal 3, the processing circuit 20 does not need to issue the job unique code.

The processing circuit 20 may register additionally setting information such as an expiration date or a limit of the number of times the job can be printed (performed). For example, the processing circuit 20 may set an expiration date got the job and register, in the job data, setting information that permits the print release of the job to occur only before the expiration date. The processing circuit 20 may set the expiration date based on an input operation by the user of the user terminal 3. For example, the user of the user terminal 3 sets the expiration date of the job via the input device 35. The user terminal 3 outputs the setting instruction for the expiration date to the server 2. The processing circuit 20 registers setting information for the expiration date in the job data. According to this example, the information processing system S can also set a validity period for the job unique code by setting an expiration date for the job. Accordingly, the information processing system S can further enhance the security when the job unique code is used. In addition, the information processing system S can also set a time limit for the print release by a permitted account by setting the expiration date of the job. Accordingly, the information processing system S can further enhance the security when the account unique code is used for print releases.

The processing circuit 20 may also set a limit on the number of times the job can be printed (performed), and register this limit in the job data. The processing circuit 20 may set the printing limit based on an input operation by the user of the user terminal 3. For example, the user of the user terminal 3 inputs the limit for the job via the input device 35. The user terminal 3 outputs the setting instruction for the limit to the server 2. The processing circuit 20 registers setting information for the limit on printing in the job data. The processing circuit 20 may set the limit on printing for the job to equal to number of permitted accounts. According to this example, the information processing system S can also set a limit on the number of times of printing using the same job unique code. Accordingly, the information processing system S can further enhance the security when the job unique code is used. In addition, the information processing system S can also set a limit on the number of print releases for the permitted accounts. Accordingly, the information processing system S can further enhance the security in printing when the account unique code is used.

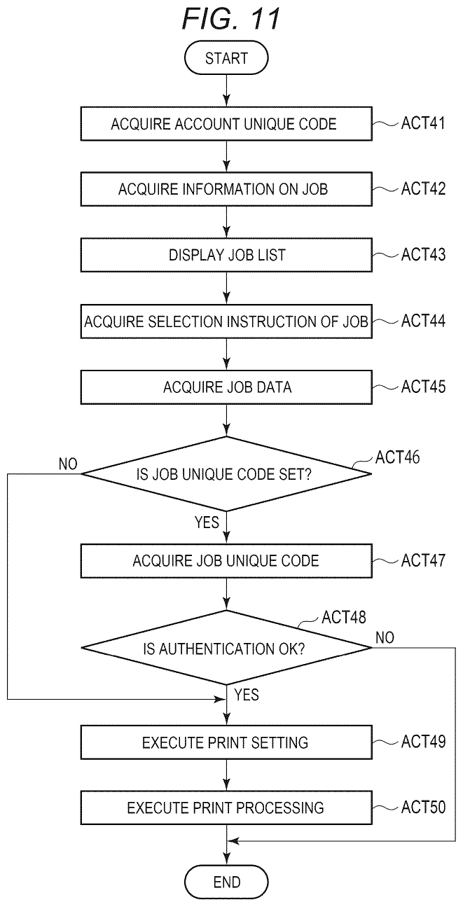

FIG. 11 is a flowchart illustrating an example of a procedure of information processing related to print processing by the image forming device 1 according to an embodiment.

In the following, it is assumed that a user who is registered for an account in the print service uses the image forming device 1 and that the user has his or her own account unique code. For example, it is assumed that the user can confirm his or her own account unique code via the print service application or the portal site of the print service. It is also assumed that the user has a job unique code for the file to be printed. For example, it is assumed that the user can confirm the job unique code of the file to be printed using the print service application or the portal site of the print service.

The image forming device 1 displays a screen image for inputting the account unique code on the display device 201. The screen image for inputting the account unique code includes an entry box or area for inputting the account unique code. The screen image for inputting the account unique code may include a “next” button or the like for skipping the input of the account unique code. The user may input his or her own account unique code via the input device 202 of the image forming device 1.

In the following processing, the image forming device 1 executes the print processing based on the setting information related to printing of the file to be printed and the setting information related to the print release.

The processing circuit 11 of the image forming device 1 implements a display processing unit, an acquisition unit, a setting processing unit, and a print processing unit. Each unit implemented by the processing circuit 11 can also be referred to as a function. Each unit implemented by the processing circuit 11 can also be referred to as being implemented by a control unit including the processing circuit 11 and the main memory 12.

The processing circuit 11 of the image forming device 1 acquires an account unique code based on a user operation (ACT 41). In ACT 41, the processing circuit 11 acquires the account unique code as input by the user. The processing circuit 11 outputs the account unique code to the server 2. The server 2 executes authentication of the account unique code. The server 2 outputs, to the image forming device 1, information about a job for which print release is permitted for the input account unique code.

The processing circuit 11 acquires, from the server 2, the information about the job for which the print release is permitted for the account unique code (ACT 42). The processing in ACT 42 may be executed by the acquisition unit.

The processing circuit 11 displays a job list on the display device 201 based on the information about the job(s) for which the print release is permitted for the account unique code (ACT 43). The processing in ACT 43 may be executed by the display processing unit. The job list is a list of jobs for which print release is permitted for the account unique code. The job list may be, for example, a list including a job ID and/or a name of file to be printed.

The processing circuit 11 acquires a selection instruction of a job for print release (ACT 44). The processing in ACT 42 may be executed by the acquisition unit. In ACT 44, the processing circuit 11 receives a selection of the job for executing the print release from the job list based on a user operation. The user selects the job for print release from the job list displayed on the display device 201 by touch input or the like. The processing circuit 11 acquires the selection instruction of the job based on the user operation. The processing circuit 11 may acquire a selection instruction for selecting a plurality of jobs. The processing circuit 11 requests job data of the selected job(s) from the server 2 based on the selection instruction. For example, the processing circuit 11 may output a job ID and a job data request for the selected job to the server 2.

The processing circuit 11 acquires the job data of the selected job from the server 2 (ACT 45). The processing in ACT 45 may be executed by the acquisition unit. The job data may include a job unique code set for the job. The job data may not include the job unique code set for the job.

The processing circuit 11 determines whether the job unique code is set in the selected job (ACT 46). The processing in ACT 46 may be executed by the setting processing unit. In ACT 46, for example, the processing circuit 11 refers to the job data and determines whether the job unique code is set in the selected job. When the job unique code is set (YES in ACT 46), the process transitions from ACT 46 to ACT 47. When the job unique code is not set (NO in ACT 46), the process transitions from ACT 46 to ACT 49.

The processing circuit 11 acquires the job unique code based on a user operation (ACT 47). The processing in ACT 47 may be executed by the acquisition unit. In ACT 47, for example, the processing circuit 11 receives an input of the job unique code via the input device 202 by the user.

The processing circuit 11 determines whether the job unique code has been authenticated (ACT 48). The processing in ACT 48 may be executed by the setting processing unit. The processing circuit 11 outputs the input job unique code to the server 2. The server 2 determines whether the job unique code has been authenticated. For example, the server 2 may compare the acquired job unique code to the job unique code recorded in the job data. When the acquired job unique code matches the job unique code recorded in the job data, the server 2 determines that the job unique code has been authenticated. When the acquired job unique code does not match the job unique code recorded in the job data, the server 2 determines that the job unique code has not been authenticated. The server 2 outputs an authentication result of the job unique code to the image forming device 1. The processing circuit 11 determines whether the job unique code has been authenticated based on the authentication result.

When the job data includes a job unique code, the processing circuit 11 may execute authentication of the job unique code based on the input job unique code. For example, the processing circuit 11 may inquire about the input job unique code and the job unique code recorded in the job data. When the input job unique code matches the job unique code recorded in the job data, the processing circuit 11 determines that the job unique code has been authenticated. When the input job unique code does not match the job unique code recorded in the job data, the processing circuit 11 determines that the job unique code has not been authenticated.

When it is determined that the job unique code has been authenticated (YES in ACT 48), the process transitions from ACT 48 to ACT 49. When it is determined that the job unique code has not been authenticated (NO in ACT 48), the process ends. In this case, the processing circuit 11 may cause the display device 201 to display an error message indicating that the job unique code is different. The processing circuit 11 may receive an input of the job unique code again. When a job unique code is acquired, the processing circuit 11 repeats the processing in ACT 47 to ACT 48.

The processing circuit 11 executes print setting based on setting information related to printing of the selected job (ACT 49). The processing in ACT 49 may be executed by the setting processing unit. In ACT 49, for example, the processing circuit 11 executes the print setting based on the job data. The processing circuit 11 may change the print setting based on a user operation.

The processing circuit 11 executes print processing of the selected job (ACT 50). The processing in ACT 50 may be executed by the print processing unit.

In ACT 42, the processing circuit 11 may acquire the job data of the job for which print release is permitted for the account unique code from the server 2. In this case, the processing in ACT 45 may be omitted.

When the user selects a plurality of jobs from the job list, the processing circuit 11 may repeat the processing in ACT 45 to ACT 50 for each selected job.

In this example, the image forming device 1 can display a job or jobs for which the print release is possible for the account unique code. The image forming device 1 can display the job(s) for which the print release is permitted by acquiring the account unique code(s) of the permitted account(s). The user can select the job for print release from a list of jobs for which the print release is possible. Therefore, the information processing system S allows a user to select from among only the jobs for which print release is permitted, thereby enhancing the security in printing of each job.

In addition, when a job unique code is set for a job, the information processing system S can execute authentication using the job unique code by requesting the job unique code. Therefore, the information processing system S can determine whether to permit a print release based on an authentication result for the job unique code. Accordingly, the information processing system S can enhance the security in printing of each job.

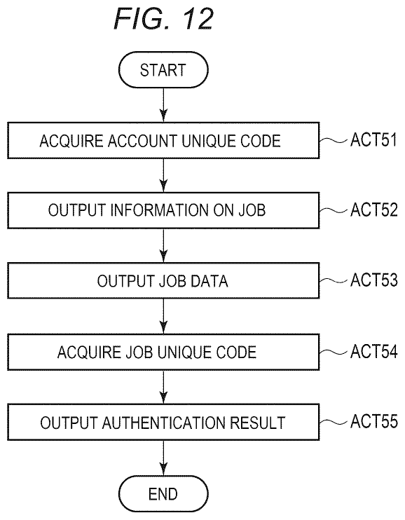

FIG. 12 is a flowchart illustrating an example of a procedure of information processing related to print processing by the server 2 according to an embodiment.

In the following, it is assumed a registered user (a user who is registered for an account) of the print service uses the image forming device 1.

The processing circuit 20 of the server 2 acquires the account unique code from the image forming device 1 (ACT 51). The processing in ACT 51 may be executed by the acquisition unit.

The processing circuit 20 outputs, to the image forming device 1, the information about the job(s) for which the print release is permitted to the account unique code (ACT 52). The processing in ACT 52 may be executed by the output unit.

The processing circuit 20 outputs the job data of a job selected by the user to the image forming device 1 based on a job data request from the image forming device 1 (ACT 53). The processing in ACT 53 may be executed by the output unit.

The processing circuit 20 acquires the job unique code from the image forming device 1 (ACT 54). The processing in ACT 54 may be executed by the acquisition unit. In ACT 54, the processing circuit 20 compares the acquired job unique code to the job unique code recorded in the job data. When the acquired job unique code matches the job unique code recorded in the job data, the processing circuit 20 determines that the job unique code has been authenticated. When the acquired job unique code does not match the job unique code recorded in the job data, the processing circuit 20 determines that the job unique code has not been authenticated.

The processing circuit 20 outputs an authentication result to the image forming device 1 (ACT 55). The processing in ACT 55 may be executed by the output unit.

In ACT 51, the processing circuit 20 may output the job data for which the print release is permitted for the account unique code to the image forming device 1. In this case, the processing in ACT 53 may be omitted.

The processing circuit 20 may delete the job data from the auxiliary storage device 22 after the output of the job data to the image forming device 1.

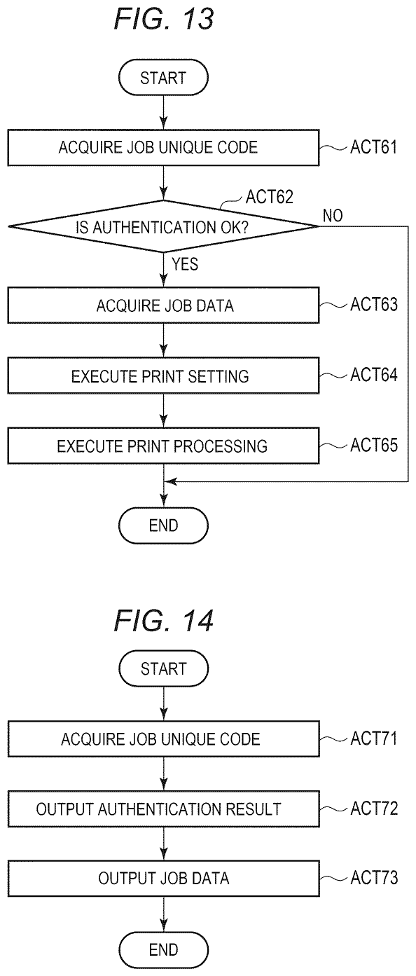

FIG. 13 is a flowchart illustrating another example of the procedure of the information processing related to the print processing by the image forming device 1 according to an embodiment.

In the following, it is assumed that a user (guest user) who is not registered with the print service uses the image forming device 1. In this case, it is assumed that the guest user knows a job unique code of the file to be printed.

Since the guest user does not have an account unique code, the image forming device 1 displays a screen image specific to the guest user on the display device 201. The screen image for the guest user can a screen image different from the screen image permitting the input of an account unique code. The screen image for the guest user does not need to include an area for inputting the account unique code. The screen image for the guest user includes an area for inputting a job unique code. The screen image for the guest user is displayed on the display device 201 based on, for example, a touch input of the “next” button included in the screen image for inputting the account unique code.

In this example, the following processing is executed for each job unique code received in this manner. When the guest user has a plurality of job unique codes to be input, the image forming device 1 executes the following processing for each job unique code input by the guest user.

The processing circuit 11 acquires a job unique code based on a user operation (ACT 61). The processing in ACT 61 may be executed by the acquisition unit. In ACT 61, the processing circuit 11 receives an input of the job unique code via the input device 202 or the like.

Similarly to ACT 48, the processing circuit 11 determines whether the job unique code can be authenticated (ACT 62). The processing in ACT 62 may be executed by the setting processing unit.

When the job unique code has been authenticated (YES in ACT 62), the process transitions from ACT 62 to ACT 63. When the job unique code has not been authenticated (NO in ACT 62), the process ends. In this case, the processing circuit 11 may cause the display device 201 to display an error message indicating that the job unique code does not match an intended job or the like. The processing circuit 11 may receive an input of a job unique code again. When the job unique code is again acquired, the processing circuit 11 repeats the processing in ACT 61 to ACT 62.

The processing circuit 11 acquires job data corresponding to the job unique code from the server 2 (ACT 63). The processing in ACT 63 may be executed by the acquisition unit. The processing circuit 11 requests the job data corresponding to the job unique code from the server 2. For example, the processing circuit 11 may output a job ID corresponding to the job unique code and a job data request to the server 2. The server 2 outputs the job data corresponding to the job unique code to the image forming device 1.

The processing circuit 11 executes print settings based on the setting information related to the job corresponding to the job unique code (ACT 64). The processing in ACT 64 may be executed by the setting processing unit. In ACT 64, the processing circuit 11 executes the print settings based on information in the job data. The processing circuit 11 may also or instead change the print settings based on a user operation at the image forming device 1.

The processing circuit 11 executes print processing of the job corresponding to the job unique code (ACT 65). The processing in ACT 65 may be executed by the print processing unit.

In this example, the image forming device 1 can request the job unique code when the print release is executed by an unspecified user. The information processing system S can execute the authentication (release permission) using the job unique code. Therefore, the information processing system S can determine whether to permit a print release based on an authentication result on the job unique code. Accordingly, the information processing system S can enhance the security in printing even for systems which permit unspecified or unregistered users to have access.

FIG. 14 is a flowchart illustrating another example of the procedure of the information processing related to the print processing by the server 2 according to an embodiment.

In the following, it is assumed that a guest user can use the image forming device 1.

The processing circuit 20 of the server 2 acquires a job unique code from the image forming device 1 (ACT 71). The processing in ACT 71 may be executed by the acquisition unit. Similarly to ACT 54, in ACT 71, the processing circuit 20 executes authentication based on the job unique code.

The processing circuit 20 outputs an authentication result to the image forming device 1 (ACT 72). The processing in ACT 72 may be executed by the output unit.

The processing circuit 20 outputs job data to the image forming device 1 for the job corresponding to the job unique code after a job data request from the image forming device 1 (ACT 73). The processing in ACT 73 may be executed by the output unit.

The processing circuit 20 may delete the job data from the auxiliary storage device 22 after the output of the job data corresponding to the job unique code to the image forming device 1.

### Other Embodiments

The information processing terminal may be implemented by single electronic device such as the user terminal 3 or may be realized as a plurality of electronic devices among which various functions are distributed.

The printer unit 700 has been described as a printer using a tandem toner image transfer unit, but is not limited thereto. The printer unit 700 may be an inkjet type printer.

An embodiment may be applied to a method executed by a device or a program capable of causing a computer to execute the described functions of the embodiment. An embodiment may be applied to a recording medium that stores a program including instructions for executing a method corresponding to an embodiment.

When the processing circuit is implemented as a single circuit, processor, or the like, the single circuit or the like executes all of the described processing. When the processing circuit is implemented as a plurality of circuits, processors, or the like, each such circuit or the like may execute different portions of the described processing or otherwise work cooperatively. When the processing circuit is implemented by a plurality of circuits, processors, or the like the plurality of circuits, processors, or the like may be included in one device, or may be distributed among a plurality of different devices.

A program of an embodiment may be transferred in already stored in a device according to an embodiment or may be separately transferred from in the device. In the latter case, the program may be transferred via a network or may be transferred by being recorded on a non-transitory, tangible recording medium that is a computer-readable medium. The form or format of such a recording medium is not limited as long as the recording medium is a medium that can store the program and be read by a computer, such as a CD-ROM or a memory card.

While certain embodiments have been described, the embodiment has been presented by way of example only and is not intended to limit the scope of the exemplary embodiments. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A print system terminal, comprising:
a communication interface to connect to a print system server; and
a processing circuit configured to:
receive, from an input unit, a selection of a selected file to be printed by a printer of a print system;
acquire print release setting information for the selected file; and
output the print release setting information and information corresponding to the selected file to the print system server.

2. The print system terminal according to claim 1, wherein the print release setting information includes a job unique code setting indicating whether print release of a job corresponding to the selected file requires input of a job unique code.

3. The print system terminal according to claim 2, wherein the print release setting information further includes a permitted account setting indicating whether the print release of the job corresponding to the selected additionally requires input of an account unique code.

4. The print system terminal according to claim 1, wherein the print release setting information includes a permitted account setting indicating whether print release of a job corresponding to the selected file requires input an account unique code.

5. The print system terminal according to claim 1, wherein
the processing circuit is further configured to:
receive, from the input unit, a selection of a plurality of selected files to be printed, and
the print release setting information includes a job unique code setting that indicates print release of individual jobs corresponding to the each of the plurality of selected files can be performed by input of the same job unique code for each of the plurality of selected files.

6. The print system terminal according to claim 1, wherein
the processing circuit is further configured to:
receive, from the input unit, a selection of a plurality of selected files to be printed, and
the print release setting information includes a job unique code setting that indicates print release of individual jobs corresponding to the each of the plurality of selected files requires by input of a different job unique code for each of the plurality of selected files.

7. The print system terminal according to claim 1, wherein the print release setting information designates a particular account unique code that is permitted to perform print release of a job corresponding to the selected file.

8. The print system terminal according to claim 7, wherein the particular account unique code is a registered user of the print system and is different from the account unique code of the user of the print system terminal.

9. A print system, comprising:
a print system terminal;
a print system server; and
a printer networked with the print system server, wherein
the print system terminal includes:
a communication interface to connect to the print system server, and
a processing circuit configured to:
receive, from an input unit, a selection of a selected file to be printed by the printer,
acquire print release setting information for the selected file, and
output the print release setting information and information corresponding to the selected file to the print system server;
the print system server includes a storage unit configured to store information related to the selected file, the information related to the selected file including the print release setting information; and
the printer is configured to:
acquire the information related to the selected file from the print system server, and
execute a job corresponding to the selected file according to the print release setting information for the selected file.

10. The print system according to claim 9, wherein the print release setting information includes a job unique code setting indicating whether print release of the job corresponding to the selected file requires input of a job unique code.

11. The print system according to claim 10, wherein the print release setting information further includes a permitted account setting indicating whether the print release of the job corresponding to the selected additionally requires input of an account unique code.

12. The print system according to claim 9, wherein the print release setting information includes a permitted account setting indicating whether print release of the job corresponding to the selected file requires input an account unique code.

13. The print system according to claim 9, wherein
the processing circuit of the print system terminal is further configured to:
receive, from the input unit, a selection of a plurality of selected files to be printed, and
the print release setting information includes a job unique code setting that indicates print release of individual jobs corresponding to the each of the plurality of selected files can be performed by input of the same job unique code for each of the plurality of selected files.

14. The print system according to claim 9, wherein
the processing circuit of the print system terminal is further configured to:
receive, from the input unit, a selection of a plurality of selected files to be printed, and
the print release setting information includes a job unique code setting that indicates print release of individual jobs corresponding to the each of the plurality of selected files requires by input of a different job unique code for each of the plurality of selected files.

15. The print system according to claim 9, wherein the print release setting information designates a particular account unique code of a registered user of the print system that is permitted to perform print release of a job corresponding to the selected file.

16. The print system according to claim 15, wherein the particular account unique code is different from the account unique code of the user of the print system terminal.

17. A print system information processing method, comprising:
receiving a selection of the file to be printed from a print system terminal;
acquiring print release setting information for the selected file from the print system terminal;
outputting the acquired print release setting information from the print system terminal to a print server networked to a printer;
storing information related to the selected file in a storage unit of the print server, the information related to the selected file including the print release setting information;
acquiring the information related to the selected file at the printer from the print system server; and
executing a job at the printer corresponding to the selected file according to the print release setting information for the selected file.

18. The method according to claim 17, wherein the print release setting information includes a job unique code setting indicating whether print release of the job corresponding to the selected file requires input of a job unique code.

19. The method according to claim 18, wherein the print release setting information further includes a permitted account setting indicating whether the print release of the job corresponding to the selected additionally requires input of an account unique code.

20. The method according to claim 17, wherein the print release setting information includes a permitted account setting indicating whether print release of the job corresponding to the selected file requires input an account unique code.
